(19) United States
(12) Patent Application Publication
(10) Pub. No.: US 2018/0350008 A1
(43) Pub. Date: Dec. 6, 2018

(54) TELEVISION INSIGHTS FROM SOCIAL ENGAGEMENTS

(71) Applicant: Facebook, Inc., Menlo Park, CA (US)

(72) Inventors: Vincent Gonguet, San Francisco, CA (US); Amaç Herdaôdelen, San Francisco, CA (US); Steven Jarrett, Berkeley, CA (US); Austin Chang, San Francisco, CA (US)

(21) Appl. No.: 15/614,254

(22) Filed: Jun. 5, 2017

(51) Int. Cl. G06Q 50/00; G06F 17/30

(52) U.S. Cl. CPC G06Q 50/01; G06F 17/30572; G06F 17/30958; G06F 17/30345; G06F 17/30522

(57) ABSTRACT

A method includes querying a social graph for social content generated by users of a social-networking system, determining a subset of the social content that is about at least one of a plurality of television programs, and determining first users who posted or interacted with the subset of social content. The method further includes generating a panel of users who have engaged with at least one of the plurality of television programs, analyzing additional posts to the social-networking system to determine particular posts that mention actors associated with the television programs, and determining second users who posted or interacted with the particular posts that mention one or more actors. The method further includes updating the panel of users by adding the second users to the panel and providing, for display in a graphical user interface, one or more television insights using the updated panel of users.

### TECHNICAL FIELD

This disclosure generally relates to social networking, and more particularly to providing television insights from social-networking engagements.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

Particular embodiments provide enhanced insights about what television programs users of a social-networking system are watching by analyzing engagements with the social-networking system such as posts, comments, and reactions. In some embodiments, social content such as posts by users to the social network are analyzed to determine which posts mention or are otherwise associated with a particular television show. The users who generated such social content or interacted with such social content (e.g., “liked” or commented on a particular post about a television program) are added to a panel of users. The panel of users generally includes users of the social network who posted or interacted with any social content on the social network that is about any television program. The panel of users may then be used to generate enhanced television insights that may be provided to any third party such as advertisers, content creators, and carriers. For example, advertisers may analyze the provided insights in order to determine which television shows are most popular or match a certain demographic. As a result, advertisers may be able to target the most desirable shows in which to advertise for their product.

In some embodiments, social content such as posts are analyzed to determine if any actors or characters associated with any television shows are included in the post. For example, if a certain post mentions a specific actor or actress (collectively “actor” herein) by name, certain embodiments may cross-reference known television programs in order to associate the post to a particular television program in which the actor appears. For example, if a user posts that “Amy Poehler is really good” on a particular day and time, certain embodiments may determine if Amy Poehler appeared in any of the television programs that were airing at that particular day and time. In this case, if the television program “Parks & Recreation” was airing at that particular day and time, embodiments may link the post and the user who generated the post to “Parks & Recreation” since Amy Poehler appears in that television program. The user who generated the post, and any other users who engaged with the post via, for example, comments and reactions, may additionally be added to the panel of users that is used to generate enhanced television insights.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates a panel of users of a social-networking system that is used to provide insights about one or more television programs.

FIGS. 2A-2B illustrate example social content that is related to a television program.

FIG. 3 illustrates a graphical user interface with example insights about a particular television program.

FIG. 4 illustrates a show ranking insight that may be displayed in the graphical user interface of FIG. 3.

FIG. 5 illustrates an engagement volume insight that may be displayed in the graphical user interface of FIG. 3.

FIG. 6 illustrates a demographic insight that may be displayed in the graphical user interface of FIG. 3.

FIG. 7 illustrates a carrier affinity insight that may be displayed in the graphical user interface of FIG. 3.

FIG. 8 illustrates an example method for providing one or more television insights using a panel of users.

FIG. 9 illustrates an example network environment associated with a social-networking system.

FIG. 10 illustrates an example social graph.

FIG. 11 illustrates an example computer system.

### DESCRIPTION OF EXAMPLE EMBODIMENTS

Analyzing viewership statistics for television programs is important for many different groups and industries. For example, advertisers desire an accurate picture of how many people are viewing particular television programs in order to decide which programs in which to place their advertisements. As another example, television networks desire accurate demographic data for television program viewership in order to determine programming lineups and schedules. Unfortunately, many existing methods of analyzing viewership of television programs are inaccurate or incomplete. For example, many viewers record and view television programs at a later time after they are initially aired. Existing methods of analyzing television program viewership typically rely solely on recording viewership of programs as they are aired, and therefore viewers who view recorded programs may not be included in the viewership statistics. As a result, advertisers and other groups may not have an accurate picture of the number and demographics of viewers for television programs.

To address these and other problems associated with existing systems, embodiments of the disclosure provide enhanced insights about what television programs users are watching by analyzing engagements with a social network. In some embodiments, social content such as posts by users to the social network are analyzed to determine which posts mention or are otherwise associated with a particular television show. The users who generated such social content or interacted with such social content (e.g., “liked” or commented on a particular post about a television program) are added to a panel of users. The panel of users generally includes users of the social network who posted or interacted with any social content on the social network that is about any television program. The panel of users may then be used to generate enhanced television insights that may be provided to any third party such as advertisers, content creators, and carriers. For example, advertisers may analyze the provided insights in order to determine which television shows are most popular or match a certain demographic. As a result, the advertisers may be able to target the most desirable shows in which to advertise for their product.

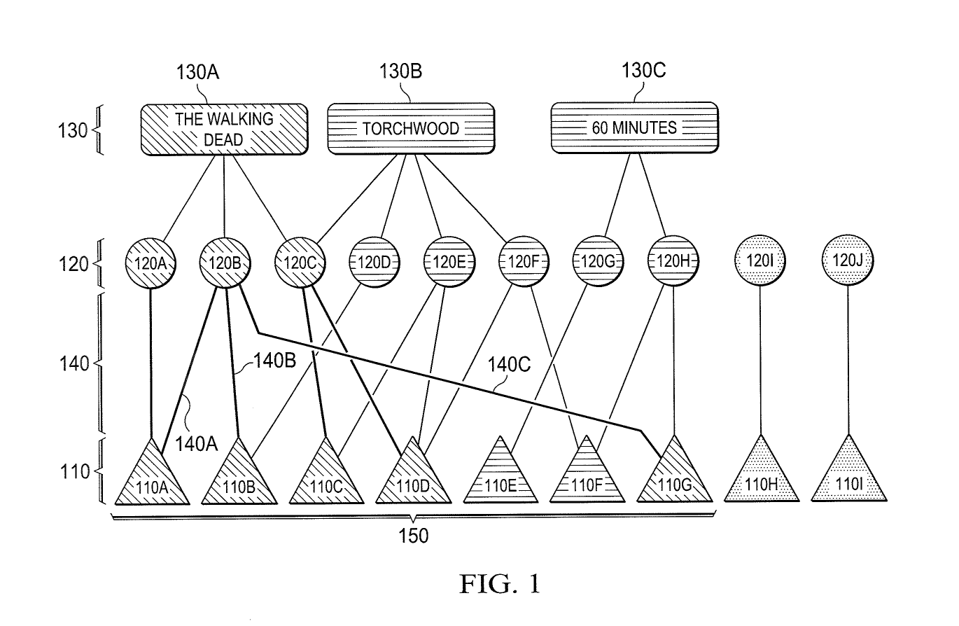

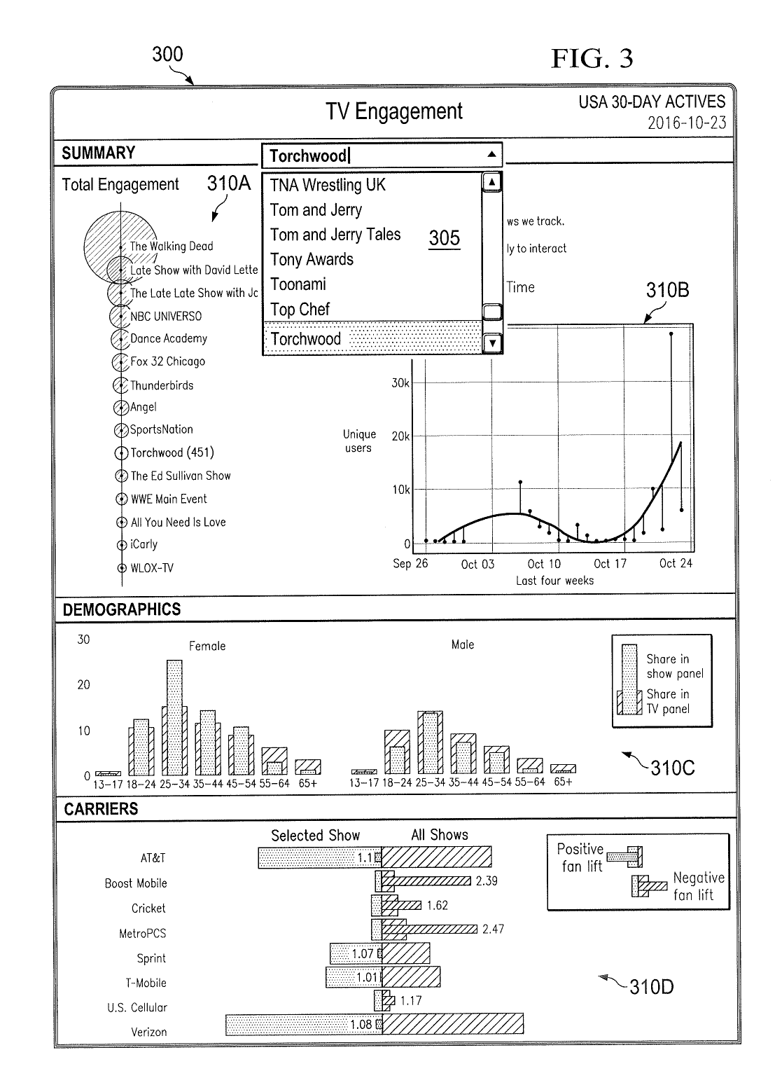

FIG. 1 illustrates a panel of users 150 of a social-networking system that may be used to provide insights about one or more television programs 130. In general, panel 150 includes multiple users 110 who have engaged (e.g., engagements 140) with social content 120 that is related to one or more television programs 130. As described in more detail below, panel 150 may be formed by analyzing social content 120. As users 110 post social content 120 to the social-networking system (or interact with social content 120 posted by other users 110 to the social-networking system), the social content 120 may be analyzed to determine if it is related to any television program 130. Any users 110 who posts or otherwise engage with social content 120 that is determined to be related to any television program 130 may be added to panel 150. Panel 150 and social content 120 may then be used to generate one or more television insights such as those illustrated in FIGS. 3-7.

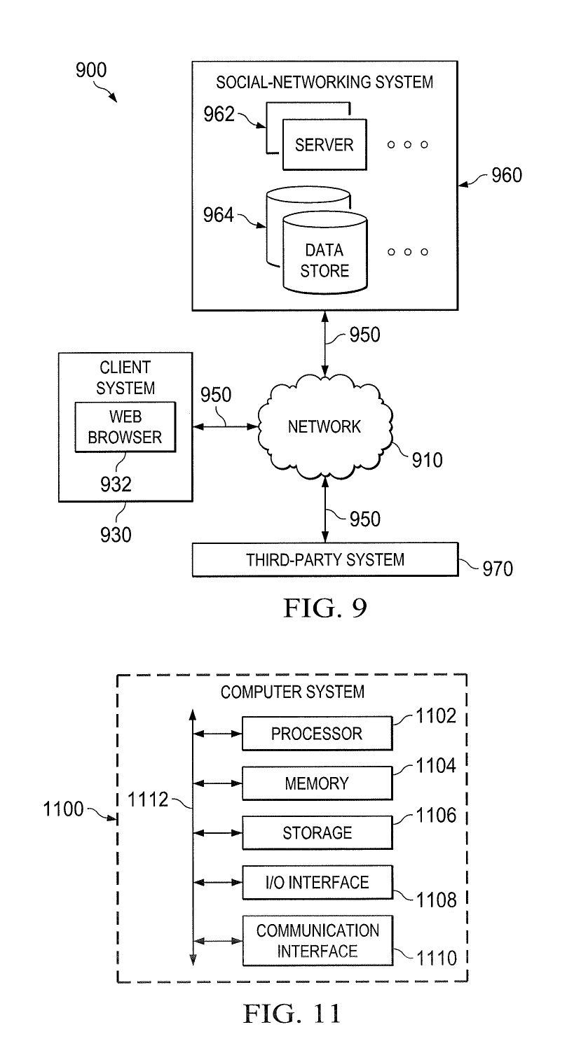

In particular embodiments, user 110 may be an individual (human user), an entity (e.g., an enterprise, business, or third-party application), or a group (e.g., of individuals or entities) that interacts or communicates with or over a social-networking system such as social-networking system 960 described below in reference to FIG. 9. In particular embodiments, one or more users 110 may use one or more client systems 930 to access, send data to, and receive data from social-networking system 960 or third-party system 970.

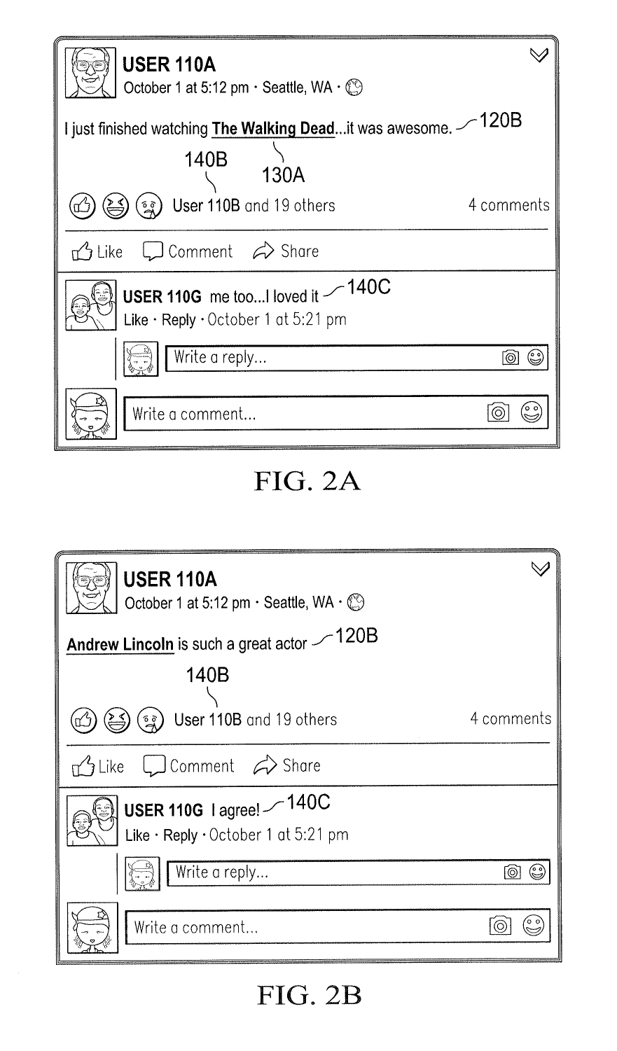

In certain embodiments, social content 120 may refer to stories, messages, posts, notifications, advertisements, newsfeeds, tickers, chat messages, one or more actions corresponding to watching a particular piece of video content, any action or reaction such as “liking” a post or particular piece of video content, or any other information from social-networking system 960. As a particular example, social content 120 may be a post that is generated by a particular user 110 and transmitted to social-networking system 960 where it is posted for viewing by connections (e.g., friends) of the particular user 110. Specific examples of social content 120 are illustrated in FIGS. 2A-B. In some embodiments, social content 120 is stored in a social graph such as social graph 1000.

Television program 130 is any program viewable on any appropriate display device such as a television or any other client system 930. In some embodiments, television program 130 is a show, movie, event (e.g., sporting event), and the like. In the illustrated example of FIG. 1, television programs 130 include a first television program 130A (i.e., “The Walking Dead”) a second television program 130B (i.e., “Torchwood”), and a third television program 130C (i.e., “60 Minutes”). While specific examples of television programs 130 are illustrated, television programs 130 may include any number or type of program.

Engagements 140 (e.g., engagements 140A-C) are any interactions that users 110 have with social content 120. For example, engagement 140A may indicate that user 110A generated and posted social content 120B about “The Walking Dead” television program 130 to social-networking system 960. As another example, engagement 140B may indicate that user 110B reacted to social content 120B about “The Walking Dead” television program 130 (e.g., “liked” social content 120B). As yet another example, engagement 140C may indicate that user 110G posted a comment to social content 120B to social-networking system 960. In some embodiments, engagements 140 are stored in a social graph such as social graph 1000 as nodes or edges of the social graph.

Panel 150 may include any number of users 110 of social-networking system 960. As described above, panel 150 includes users 110 who have engaged (e.g., engagements 140) with social content 120 that is related to one or more television programs 130. In the example of FIG. 1, panel 150 includes users 110A-G since they have engaged with social content 120A-120H, which are each about one of television programs 130. Users 110H-I, however, are not included in panel 150 since they have not engaged with any social content 120 that is about television programs 130.

FIGS. 2A-2B illustrate example social content 120B that is related to a television program 130. In FIG. 2A, user 110A has posted social content 120B to social-networking system 960 of “I just finished watching The Walking Dead . . . it was awesome.” User 110B has reacted to social content 120B by liking the post or selecting any other appropriate reaction (e.g., happy, anger, laugh, etc.), which is indicated by engagement 140B. User 110G has posted a comment of “me too . . . I loved it” to social content 120B, which is indicated by engagement 140C. As discussed in more detail below, social content 120B is linked to television program 130A of “The Walking Dead” by social-networking system 960 since the post specifically mention television program 130A. As a result, user 110A (who posted social content 120B to social-networking system 960) may be added to panel 150. Likewise, users 110B and 110G may also be added to panel 150 since they engaged with social content 120B via engagements 140B and 140C, respectively.

In FIG. 2B, user 110A has posted social content 120B to social-networking system 960 of “Andrew Lincoln is such a great actor.” User 110B has reacted to social content 120B by liking the post or selecting any other appropriate reaction (e.g., happy, anger, laugh, etc.), which is indicated by engagement 140B. User 110G has posted a comment of “I agree!” to social content 120B, which is indicated by engagement 140C. As discussed in more detail below, social content 120B is linked to television program 130A of “The Walking Dead” by social-networking system 960 since the post mentions an actor (i.e., Andrew Lincoln) who appears in television program 130A. As a result, user 110A (who posted social content 120B to social-networking system 960) may be added to panel 150. Likewise, users 110B and 110G may also be added to panel 150 since they engaged with social content 120B via engagements 140B and 140C, respectively.

In operation of example embodiments of FIGS. 1-2B, social-networking system 960 builds and updates panel 150 using social content 120 and engagements 140 in order to provide enhanced insights into television programs 130. For example, as users 110 generate social content 120 such as posts, comments, or reactions, the social content 120 may be analyzed by social-networking system 960 to determine if it is related to any television program 130. In some embodiments, social content 120 may be analyzed in real-time as it is posted to social-networking system 960 (e.g., within a certain amount of time after it has been posted). In other embodiments, social content 120 may be batch analyzed periodically or at certain time intervals to determine if any social content 120 is related to any television program 130. Once particular social content 120 has been identified as being related to a particular television program 130, social-networking system 960 may then identify any users 110 who created or engaged with the particular social content 120 that is related to the particular television program 130. In the example embodiments of FIGS. 2A-2B above, such users would include users 110A, 110B, and 110G. Once users 110 who created or engaged with the particular social content 120 that is related to the particular television program 130 have been identified, they may be added to panel 150 and used to generate television insights such as insights 310A-D described below.

In some embodiments, social-networking system 960 determines that social content 120 is related to a particular television program 130 by identifying television programs 130 that are specifically mentioned by name in social content 120. Using the embodiment of FIG. 2A as an example, social-networking system 960 analyzes the text of social content 120B of “I just finished watching The Walking Dead . . . it was awesome” to determine if any television programs 130 were mentioned. For example, social-networking system 960 may cross-reference the text of social content 120B with any appropriate database of known television shows to determine if any of the known television shows were included in the text. As a specific example, social-networking system 960 may cross-reference the text of social content 120B with publicly-available online databases such as Wikipedia, IMDb, or any other online encyclopedia or information source. In this case, “The Walking Dead” is a known television program 130A. As a result, social-networking system 960 may associate social content 120B of FIG. 2A with “The Walking Dead” television program 130A.

In some embodiments, social-networking system 960 determines that social content 120 is related to a particular television program 130 by identifying actors or characters who are mentioned in social content 120. Similar to above, social-networking system 960 may cross-reference the text of social content 120B with publicly-available online databases such as Wikipedia, IMDb, or any other online encyclopedia or information source to determine if any known actor or character was included in the text of social content 120. Using the embodiment of FIG. 2B as an example, social-networking system 960 may analyze the text of social content 120B of “Andrew Lincoln is such a great actor” to determine if any television actors were mentioned. In this case, “Andrew Lincoln” is a known actor in the television program 130A “The Walking Dead.” As a result, social-networking system 960 may associate social content 120B of FIG. 2B with “The Walking Dead” television program 130A. As another example, consider the scenario if the text of social content 120B instead was “Rick Grimes was awesome tonight.” In this case, “Rick Grimes” is a known character played by actor Andrew Lincoln in the television program 130A “The Walking Dead.” As a result, social-networking system 960 may associate social content 120B of FIG. 2B with “The Walking Dead” television program 130A.

In some embodiments, metadata associated with social content 120 may be utilized by social-networking system 960 to determine if social content 120 is associated with a television program 130. As one example, if metadata such as a timestamp indicates that social content 120B of FIG. 2B was posted by user 110A at 5:12 PM on October 1, this metadata may be used to cross-reference known television programs 130 that were airing at that time to help determine if the social content 120B should be associated with a particular television program 130. In this example in which actor “Andrew Lincoln” was mentioned in social content 120B, social-networking system 960 may analyze television programs 130 that were airing at 5:12 PM on October 1 to determine if actor “Andrew Lincoln” appeared in any particular television program 130. If so, social-networking system 960 may associate social content 120B of FIG. 2B with the television program 130 that was airing at 5:12 PM on October 1 and included actor “Andrew Lincoln.” This may be especially useful when particular actors appear in more than one television show. For example, if actor “Andrew Lincoln” currently stars in three television shows, but only one of the shows (e.g., “The Walking Dead” television program 130A) was airing when user 110A posted social content 120B of “Andrew Lincoln is such a great actor,” then social-networking system 960 may be able to more accurately determine that social content 120B should be associated with the actor's particular show that was airing at that time.

In some embodiments, location metadata of social content 120 may also be utilized by social-networking system 960 to determine which users 110 or social content 120 are associated with a television program 130. For example, location metadata of social content 120B may indicate that user 110A was at a specific address when they posted “I just finished watching The Walking Dead . . . it was awesome” at 5:12 PM on October 1. Social-networking system 960 may analyze location metadata of other social content 120 (e.g., other posts by friends or connections of user 110A in social graph 1000) to determine if any other users 110 were at the same address as user 110A when they posted social content 120B. If social-networking system 960 determines that, for example, user 110C was at the same address as user 110A when they posted social content 120B, social-networking system 960 may infer that user 110C also viewed “The Walking Dead” television program 130A. As a result, user 110C may also be added to panel 150.

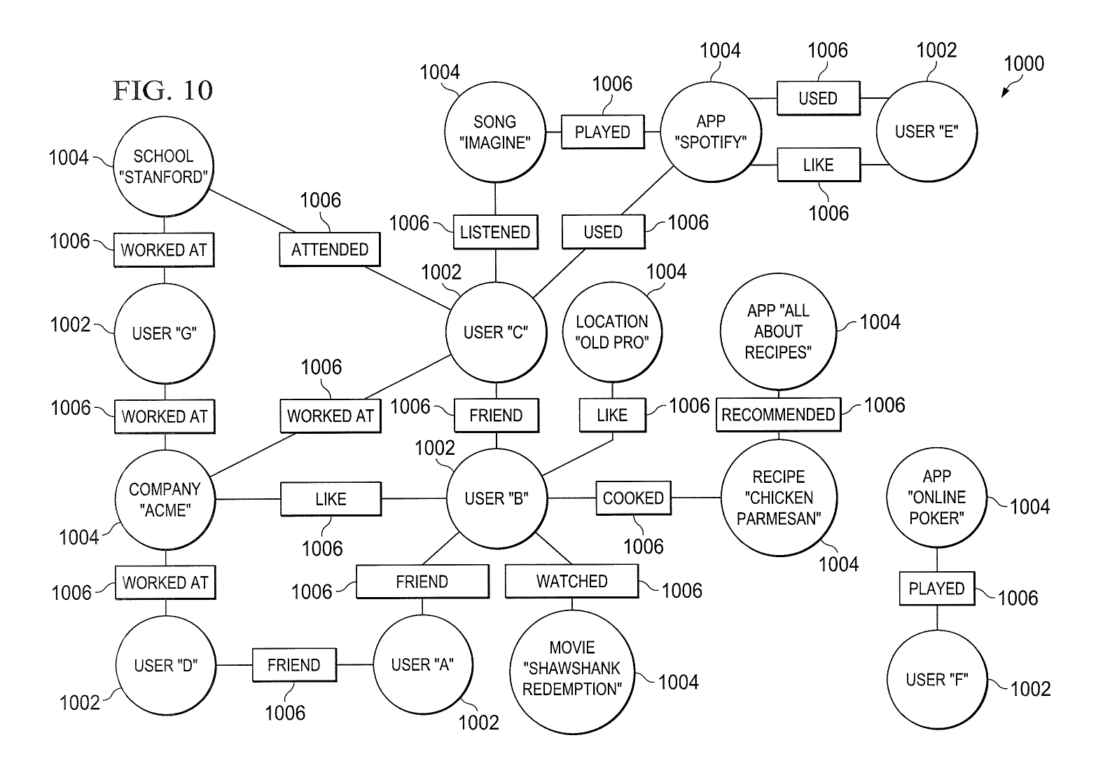

In some embodiments, once social-networking system 960 determines that particular social content 120 is associated with a particular television program 130, one or more edges may be added to a social graph to reflect and record the association. For example, an edge 1006 as described below in reference to FIG. 10 may be added to social graph 1000 to indicate the association between particular social content 120 and a particular television program 130. Using the embodiments of FIGS. 2A and 2B, an edge 1006 may be added between a node for social content 120B and a node 1004 for television program 130A. In some embodiments, an edge 1006 may be added between a user node for user 110 and a node 1004 for a particular television program 130 if it is determined that the particular user 110 created or engaged with social content 120 that is associated with the particular television program 130. Using the embodiments of FIGS. 2A and 2B as an example, edges 1006 may be added between a node 1004 of “The Walking Dead” television program 130B and nodes 1002 of users 110A, 110B, and 110G. In some embodiments, social-networking system 960 may utilize such data from social graph 1000 to build and update panel 150.

In some embodiments, topic tagging may be used by social-networking system 960 to determine television programs 130 and actors that are mentioned within social content 120 such as posts. For example, a topic tagger such as topic tagger 304 as disclosed in U.S. patent application Ser. No. 14/981,626, filed 28 Dec. 2015, which is incorporated herein by reference in its entirety, may be used to identify input topics in the social content 120. The input topics may include words or phrases that are present in the social content 120 such as names of television programs 130 and actors. For example, for social content 120B that has the text “Andrew Lincoln is such a great actor,” the topic tagger may identify “Andrew Lincoln” as an input topic. The input topics may then be used to determine if social content 120 is related to a particular television programs 130. In some embodiments, social-networking system 960 may utilize a topic tagger to identify topics associated with identified objects, as disclosed in U.S. patent application Ser. No. 14/470583, filed 27 Aug. 2014, which is incorporated herein by reference in its entirety.

FIG. 3 illustrates a graphical user interface (“GUI”) 300 that includes example insights 310 that are about a selected television program 130. In general, GUI 300 may be displayed on any appropriate display device such as a smartphone, computer, or tablet. In some embodiments, GUI 300 includes a user-selectable list of television shows 305 that allows a user 110 to select a particular television programs 130 on which to base insights 310. In particular, a user 110 may select one of the television programs 130 that are listed in user-selectable list 305 and then view one or more insights 310 for the selected program that are generated based on panel 150. For example, if the selected program is “Torchwood,” insights 310 are generated using users 110 in panel 150 who have engaged with social content 120 associated with “Torchwood” television program 130. Since panel 150 contains users 110 who have engaged with at least one television program 130 on social-networking system 960 (e.g., via social content 120 or engagements 140), insights 310 provide a more extensive and thorough picture of how many people are actually viewing the selected television program. As a result, advertisers and other third parties may be able to make better decisions regarding, for example, which programs to place advertisements.

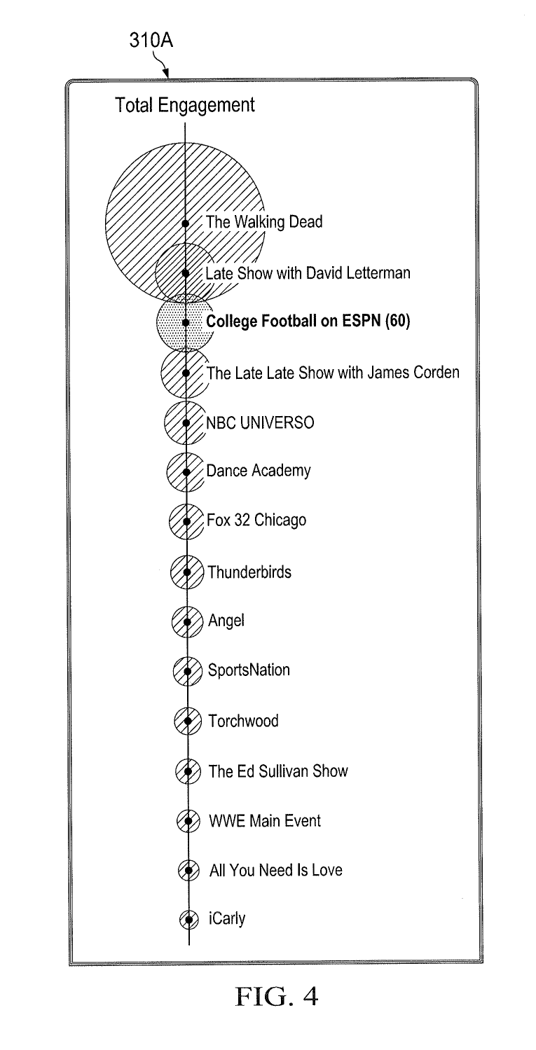

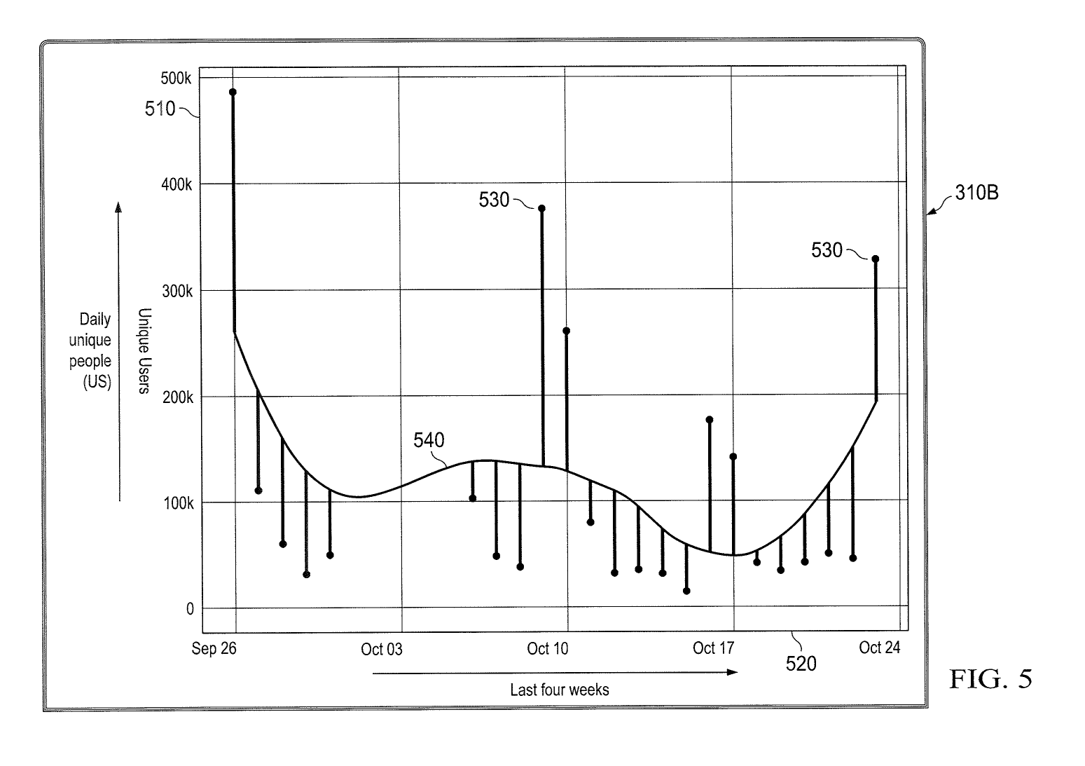

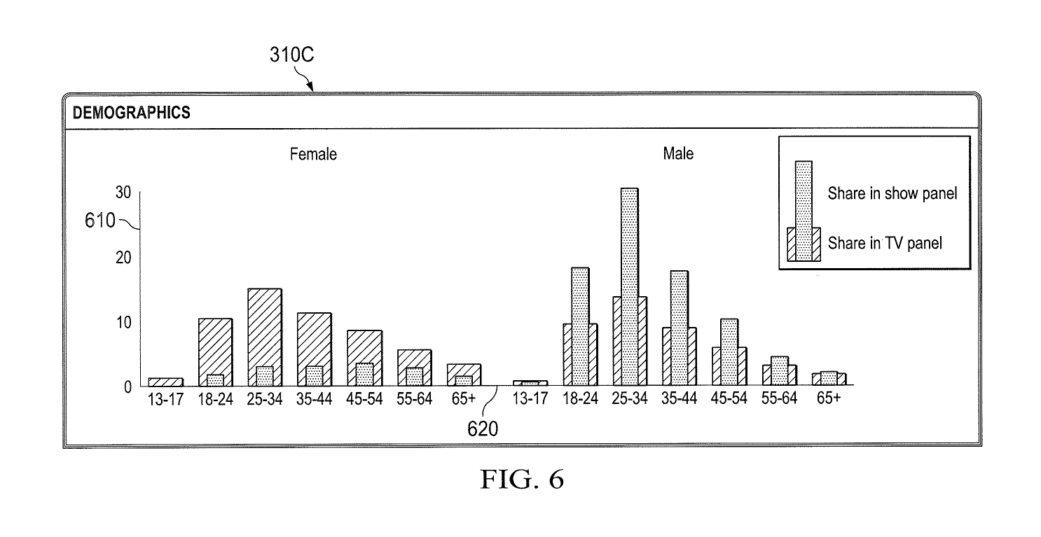

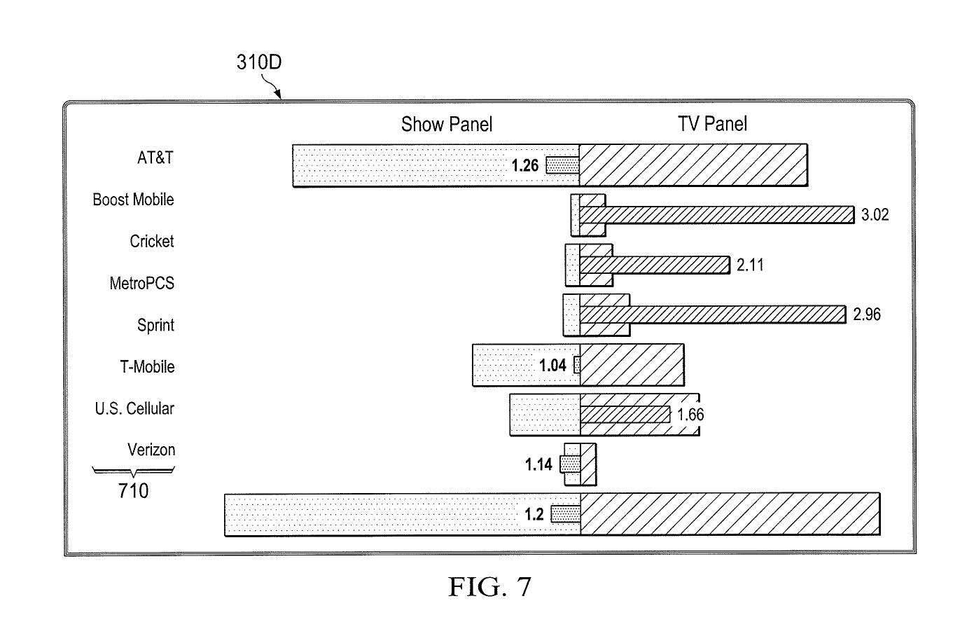

GUI 300 includes a show ranking insight 310A, an engagement volume insight 310B, a demographic insight 310C, and a carrier affinity insight 310D. Show ranking insight 310A is shown in more detail in FIG. 4, engagement volume insight 310B is shown in more detail in FIG. 5, demographic insight 310C is shown in more detail in FIG. 6, and carrier affinity insight 310D is shown in more detail in FIG. 7. While particular insights 310 are illustrated in FIG. 3, other embodiments may include any other number or type of insights 310.

FIG. 4 illustrates a show ranking insight 310A that may be displayed in GUI 300 of FIG. 3. In general, show ranking insight 310A provides a visual representation of a ranking of engagements with television programs 130 based on users 110 in panel 150. More specifically, social-networking system 960 may determine a number of engagements 140 by users 110 in panel 150 with social content 120 that is associated with television programs 130. An amount of engagements 140 with each particular television program 130 may be determined and then used to rank television programs 130 by number of engagements 140 (e.g., fewest to most or most to fewest). In the illustrated example of FIG. 4, “The Walking Dead” television programs 130 is determined to have the most engagements 140 and “iCarly” is determined to have the 15th most engagements 140. While a specific number of television programs 130 are illustrated in FIG. 4, other embodiments may display any number of television programs 130.

FIG. 5 illustrates an engagement volume insight 310B that may be displayed in GUI 300 of FIG. 3. In general, engagement volume insight 310B displays an amount of engagements 140 by panel 150 for a selected television program 130 over a certain time period. In some embodiments, engagement volume insight 310B may include an first axis 510 and a second axis 520. First axis 510 may indicate the number of unique users 110 within panel 150 that have engaged with the selected television program 130. Second axis 520 may indicate a date or time period. In the illustrated embodiment of FIG. 5, second axis 520 covers the previous four weeks and is divided into days within that time period. Other embodiment may cover other time periods and may be divided into any appropriate time periods. In some embodiments, the time period of engagement volume insight 310B (i.e., the extent of second axis 520) may be selectable by the user within, for example, GUI 300. In some embodiments, as illustrated in FIG. 5, the amount of unique users 110 within panel 150 that have engaged with the selected television program 130 are plotted as points 530 on the graph, and a curve 540 may be displayed between points 530. In some embodiments, curve 540 is a fitted curve, but may be any appropriate curve in other embodiments.

FIG. 6 illustrates a demographic insight 310C that may be displayed in GUI 300 of FIG. 3. In general, demographic insight 310C provides a graphical representation of engagement volume by panel 150 for a selected television program 130 for selected demographics (e.g., gender, age, race, etc.). In the illustrated embodiment of FIG. 6, for example, demographic insight 310C provides a graphical representation of engagement volume by panel 150 for a selected television program 130 according to gender and age. In some embodiments, demographic insight 310C may include a first axis 610 and a second axis 620. First axis 610 may indicate the number of unique users 110 within panel 150 that have engaged with the selected television program 130. Second axis 620 may indicate a selected demographic such as age. In the illustrated embodiment of FIG. 6, second axis 620 is divided into age ranges of users 110 within panel 150 that have engaged with the selected television program 130. In some embodiments, the demographics of demographic insight 310C may be selectable by the user within, for example, GUI 300.

In FIG. 6, two different demographics of users 110 within panel 150 who engaged with the selected television program 130 are shown: age and gender. Second axis 620 is divided into female and male and further by age group (e.g., 13-17, 18-24, etc.). The number of unique users 110 within panel 150 that have engaged with the selected television program 130 for each gender and age group are then plotted as bar graphs as illustrated. In addition, each bar within demographic insight 310C may be further divided according to shares (e.g., percentages or proportions) within the entire panel 150 and shares within the portion of panel 150 for the selected television programs 130.

FIG. 7 illustrates a carrier affinity insight 310D that may be displayed in GUI 300 of FIG. 3. In general, carrier affinity insight 310D provides a graphical representation of engagement volume by panel 150 for a selected television program 130 for certain carriers 170 (e.g., AT&T, Verizon, etc.). As illustrated in FIG. 7, some embodiments of carrier affinity insight 310D provide shares (e.g., percentages or proportions) for each carrier 170 for both the entire panel 150 and the portion of panel 150 for the selected television program 130. In other words, carrier affinity insight 310D may display for each particular carrier 170: what percentage of the entire panel 150 used the particular carrier, and what percentage of the users in panel 150 who engaged with the selected television program 130 used the particular carrier. In addition, some embodiments of carrier affinity insight 310D may include an affinity score. For example, in the embodiment of FIG. 7, an affinity score for AT&T is shown as 1.26. In general, the affinity score is the division of the maximum left or right distribution value for AT&T divided by the minimum left or right distribution for AT&T. In this case, the left side (show panel) is larger than the right side (overall TV panel) for AT&T. So 1.26 indicates that an AT&T customer is 1.26 times (or 26%) more likely to watch the show selected than anyone in the overall TV panel. This may give advertisers a clearer picture of which carrier 170 to advertise for a specific television program 130.

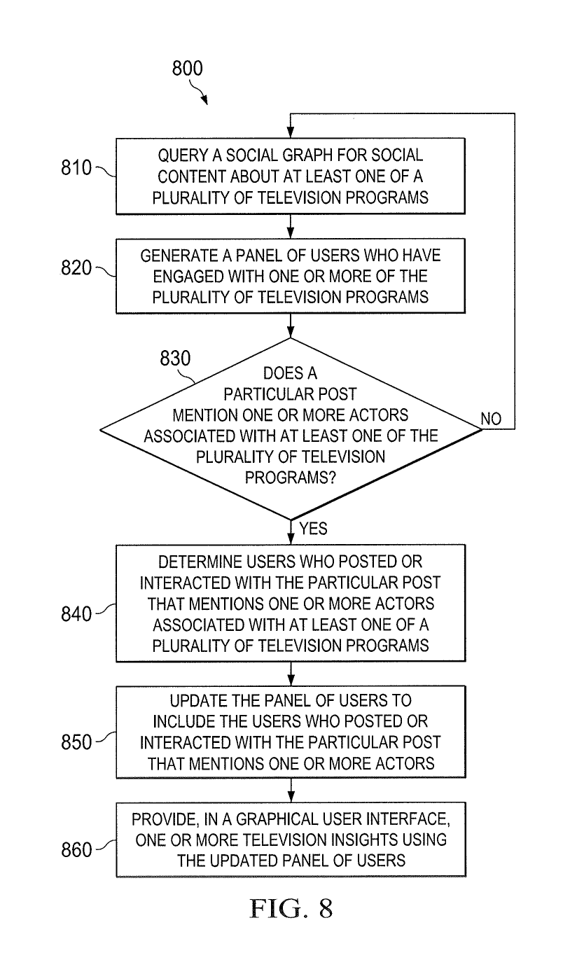

FIG. 8 illustrates an example method 800 for providing one or more television insights using a panel of users. The method may begin at step 810, where a social graph of social-networking system is queried for social content about at least one of a plurality of television programs. In some embodiments, the social graph is social graph 1000 and the social-networking system is social-networking system 960. In some embodiments, the social content is social content 120 such as posts, comments, and reactions. In some embodiments, the television programs are television programs 130. In some embodiments, step 810 includes determining whether the social content mentions a specific television program or actor by name. In some embodiments, topic tagging may be utilized to determine whether the social content mentions a specific television program or actor by name.

At step 820, a panel of users who have engaged with one or more of the plurality of television programs on the social-networking system is generated. In some embodiments, the panel of users includes a first plurality of users who posted or interacted with the social content of step 810 that is about at least one of a plurality of television programs. In some embodiments, the panel of users is panel 150. In some embodiments, a user is determined to have engaged with one or more of the plurality of television programs by analyzing engagements such as engagements 140. In some embodiments, generating the panel of step 820 includes forming a list (e.g., an electronic list or database) of users of the social-networking system who have engaged with one or more of the plurality of television programs on the social-networking system.

At step 830, method 800 determines whether a particular post mentions one or more actors who are associated with at least one of the plurality of television programs. In some embodiments, topic tagging may be utilized to determine whether the post mentions a specific actor by name. In some embodiments, method 800 may cross-reference the text of the particular post with publicly-available online databases such as Wikipedia, IMDb, or any other online encyclopedia or information source to determine if any known actor was included in the text of the post. If it is determined that the post mentions an actor, method 800 may proceed to step 840. Otherwise, method 800 may proceed back to step 810 or may end.

At step 840, method 800 determines a plurality of second users of the social-networking system who posted or interacted with at least one of the particular posts of step 830 that mention one or more actors associated with at least one of a plurality of television programs. In some embodiments, the second users include any users who posted, commented on, or reacted to one of the posts of step 830. In some embodiments, metadata such as time and location metadata may be used to determine the second users as described above.

At step 850, method 800 updates the panel of users who have engaged with one or more of plurality of television programs on the social-networking system to include the plurality of second users from step 840. At step 860, method 800 provides, in a graphical user interface, one or more television insights using the updated panel of users from step 850 who have engaged with one or more of plurality of television programs on the social-networking system. In some embodiments, the graphical user interface of step 860 is GUI 300. In some embodiments, the one or more television insights of step 850 include one or more of insights 310. After step 860, method 800 may end.

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for providing one or more television insights using a panel of users including the particular steps of the method of FIG. 8, this disclosure contemplates any suitable method for providing one or more television insights using a panel of users including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

FIG. 9 illustrates an example network environment 900 associated with a social-networking system. Network environment 900 includes a client system 930, a social-networking system 960, and a third-party system 970 connected to each other by a network 910. Although FIG. 9 illustrates a particular arrangement of client system 930, social-networking system 960, third-party system 970, and network 910, this disclosure contemplates any suitable arrangement of client system 930, social-networking system 960, third-party system 970, and network 910. As an example and not by way of limitation, two or more of client system 930, social-networking system 960, and third-party system 970 may be connected to each other directly, bypassing network 910. As another example, two or more of client system 930, social-networking system 960, and third-party system 970 may be physically or logically co-located with each other in whole or in part. Moreover, although FIG. 9 illustrates a particular number of client systems 930, social-networking systems 960, third-party systems 970, and networks 910, this disclosure contemplates any suitable number of client systems 930, social-networking systems 960, third-party systems 970, and networks 910. As an example and not by way of limitation, network environment 900 may include multiple client system 930, social-networking systems 960, third-party systems 970, and networks 910.

This disclosure contemplates any suitable network 910. As an example and not by way of limitation, one or more portions of network 910 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 910 may include one or more networks 910.

[50] Links 950 may connect client system 930, social-networking system 960, and third-party system 970 to communication network 910 or to each other. This disclosure contemplates any suitable links 950. In particular embodiments, one or more links 950 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 950 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 950, or a combination of two or more such links 950. Links 950 need not necessarily be the same throughout network environment 900. One or more first links 950 may differ in one or more respects from one or more second links 950.

In particular embodiments, client system 930 may be an electronic device including hardware, software, or embedded logic components or a combination of two or more such components and capable of carrying out the appropriate functionalities implemented or supported by client system 930. As an example and not by way of limitation, a client system 930 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 930. A client system 930 may enable a network user at client system 930 to access network 910. A client system 930 may enable its user to communicate with other users at other client systems 930.

In particular embodiments, client system 930 may include a web browser 932, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 930 may enter a Uniform Resource Locator (URL) or other address directing the web browser 932 to a particular server (such as server 962, or a server associated with a third-party system 970), and the web browser 932 may generate a Hyper Text Transfer Protocol (HTTP) request and communicate the HTTP request to server. The server may accept the HTTP request and communicate to client system 930 one or more Hyper Text Markup Language (HTML) files responsive to the HTTP request. Client system 930 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 960 may be a network-addressable computing system that can host an online social network. Social-networking system 960 may generate, store, receive, and send social-networking data, such as, for example, user-profile data, concept-profile data, social-graph information, or other suitable data related to the online social network. Social-networking system 960 may be accessed by the other components of network environment 900 either directly or via network 910. As an example and not by way of limitation, client system 930 may access social-networking system 960 using a web browser 932, or a native application associated with social-networking system 960 (e.g., a mobile social-networking application, a messaging application, another suitable application, or any combination thereof) either directly or via network 910. In particular embodiments, social-networking system 960 may include one or more servers 962. Each server 962 may be a unitary server or a distributed server spanning multiple computers or multiple datacenters. Servers 962 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 962 may include hardware, software, or embedded logic components or a combination of two or more such components for carrying out the appropriate functionalities implemented or supported by server 962. In particular embodiments, social-networking system 960 may include one or more data stores 964. Data stores 964 may be used to store various types of information. In particular embodiments, the information stored in data stores 964 may be organized according to specific data structures. In particular embodiments, each data store 964 may be a relational, columnar, correlation, or other suitable database. Although this disclosure describes or illustrates particular types of databases, this disclosure contemplates any suitable types of databases. Particular embodiments may provide interfaces that enable a client system 930, a social-networking system 960, or a third-party system 970 to manage, retrieve, modify, add, or delete, the information stored in data store 964.

In particular embodiments, social-networking system 960 may store one or more social graphs in one or more data stores 964. In particular embodiments, a social graph may include multiple nodes—which may include multiple user nodes (each corresponding to a particular user) or multiple concept nodes (each corresponding to a particular concept)—and multiple edges connecting the nodes. Social-networking system 960 may provide users of the online social network the ability to communicate and interact with other users. In particular embodiments, users may join the online social network via social-networking system 960 and then add connections (e.g., relationships) to a number of other users of social-networking system 960 to whom they want to be connected. Herein, the term “friend” may refer to any other user of social-networking system 960 with whom a user has formed a connection, association, or relationship via social-networking system 960.

In particular embodiments, social-networking system 960 may provide users with the ability to take actions on various types of items or objects, supported by social-networking system 960. As an example and not by way of limitation, the items and objects may include groups or social networks to which users of social-networking system 960 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 960 or by an external system of third-party system 970, which is separate from social-networking system 960 and coupled to social-networking system 960 via a network 910.

In particular embodiments, social-networking system 960 may be capable of linking a variety of entities. As an example and not by way of limitation, social-networking system 960 may enable users to interact with each other as well as receive content from third-party systems 970 or other entities, or to allow users to interact with these entities through an application programming interfaces (API) or other communication channels.

In particular embodiments, a third-party system 970 may include one or more types of servers, one or more data stores, one or more interfaces, including but not limited to APIs, one or more web services, one or more content sources, one or more networks, or any other suitable components, e.g., that servers may communicate with. A third-party system 970 may be operated by a different entity from an entity operating social-networking system 960. In particular embodiments, however, social-networking system 960 and third-party systems 970 may operate in conjunction with each other to provide social-networking services to users of social-networking system 960 or third-party systems 970. In this sense, social-networking system 960 may provide a platform, or backbone, which other systems, such as third-party systems 970, may use to provide social-networking services and functionality to users across the Internet.

In particular embodiments, a third-party system 970 may include a third-party content object provider. A third-party content object provider may include one or more sources of content objects, which may be communicated to a client system 930. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 960 also includes user-generated content objects, which may enhance a user's interactions with social-networking system 960. User-generated content may include anything a user can add, upload, send, or “post” to social-networking system 960. As an example and not by way of limitation, a user communicates posts to social-networking system 960 from a client system 930. Posts may include data such as status updates or other textual data, location information, photos, videos, links, music or other similar data or media. Content may also be added to social-networking system 960 by a third-party through a “communication channel,” such as a newsfeed or stream.

In particular embodiments, social-networking system 960 may include a variety of servers, sub-systems, programs, modules, logs, and data stores. In particular embodiments, social-networking system 960 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 960 may also include suitable components such as network interfaces, security mechanisms, load balancers, failover servers, management-and-network-operations consoles, other suitable components, or any suitable combination thereof. In particular embodiments, social-networking system 960 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 960 to one or more client systems 930 or one or more third-party system 970 via network 910. The web server may include a mail server or other messaging functionality for receiving and routing messages between social-networking system 960 and one or more client systems 930. An API-request server may allow a third-party system 970 to access information from social-networking system 960 by calling one or more APIs. An action logger may be used to receive communications from a web server about a user's actions on or off social-networking system 960. In conjunction with the action log, a third-party-content-object log may be maintained of user exposures to third-party-content objects. A notification controller may provide information regarding content objects to a client system 930. Information may be pushed to a client system 930 as notifications, or information may be pulled from client system 930 responsive to a request received from client system 930. Authorization servers may be used to enforce one or more privacy settings of the users of social-networking system 960. A privacy setting of a user determines how particular information associated with a user can be shared. The authorization server may allow users to opt in to or opt out of having their actions logged by social-networking system 960 or shared with other systems (e.g., third-party system 970), such as, for example, by setting appropriate privacy settings. Third-party-content-object stores may be used to store content objects received from third parties, such as a third-party system 970. Location stores may be used for storing location information received from client systems 930 associated with users. Advertisement-pricing modules may combine social information, the current time, location information, or other suitable information to provide relevant advertisements, in the form of notifications, to a user.

FIG. 10 illustrates example social graph 1000. In particular embodiments, social-networking system 960 may store one or more social graphs 1000 in one or more data stores. In particular embodiments, social graph 1000 may include multiple nodes—which may include multiple user nodes 1002 or multiple concept nodes 1004—and multiple edges 1006 connecting the nodes. Example social graph 1000 illustrated in FIG. 10 is shown, for didactic purposes, in a two-dimensional visual map representation. In particular embodiments, a social-networking system 960, client system 930, or third-party system 970 may access social graph 1000 and related social-graph information for suitable applications. The nodes and edges of social graph 1000 may be stored as data objects, for example, in a data store (such as a social-graph database). Such a data store may include one or more searchable or queryable indexes of nodes or edges of social graph 1000.

In particular embodiments, a user node 1002 may correspond to a user of social-networking system 960. As an example and not by way of limitation, a user may be an individual (human user), an entity (e.g., an enterprise, business, or third-party application), or a group (e.g., of individuals or entities) that interacts or communicates with or over social-networking system 960. In particular embodiments, when a user registers for an account with social-networking system 960, social-networking system 960 may create a user node 1002 corresponding to the user, and store the user node 1002 in one or more data stores. Users and user nodes 1002 described herein may, where appropriate, refer to registered users and user nodes 1002 associated with registered users. In addition or as an alternative, users and user nodes 1002 described herein may, where appropriate, refer to users that have not registered with social-networking system 960. In particular embodiments, a user node 1002 may be associated with information provided by a user or information gathered by various systems, including social-networking system 960. As an example and not by way of limitation, a user may provide his or her name, profile picture, contact information, birth date, sex, marital status, family status, employment, education background, preferences, interests, or other demographic information. In particular embodiments, a user node 1002 may be associated with one or more data objects corresponding to information associated with a user. In particular embodiments, a user node 1002 may correspond to one or more webpages.

In particular embodiments, a concept node 1004 may correspond to a concept. As an example and not by way of limitation, a concept may correspond to a place (such as, for example, a movie theater, restaurant, landmark, or city); a website (such as, for example, a website associated with social-network system 960 or a third-party website associated with a web-application server); an entity (such as, for example, a person, business, group, sports team, or celebrity); a resource (such as, for example, an audio file, video file, digital photo, text file, structured document, or application) which may be located within social-networking system 960 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 1004 may be associated with information of a concept provided by a user or information gathered by various systems, including social-networking system 960. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 1004 may be associated with one or more data objects corresponding to information associated with concept node 1004. In particular embodiments, a concept node 1004 may correspond to one or more webpages.

In particular embodiments, a node in social graph 1000 may represent or be represented by a webpage (which may be referred to as a “profile page”). Profile pages may be hosted by or accessible to social-networking system 960. Profile pages may also be hosted on third-party websites associated with a third-party system 970. As an example and not by way of limitation, a profile page corresponding to a particular external webpage may be the particular external webpage and the profile page may correspond to a particular concept node 1004. Profile pages may be viewable by all or a selected subset of other users. As an example and not by way of limitation, a user node 1002 may have a corresponding user-profile page in which the corresponding user may add content, make declarations, or otherwise express himself or herself. As another example and not by way of limitation, a concept node 1004 may have a corresponding concept-profile page in which one or more users may add content, make declarations, or express themselves, particularly in relation to the concept corresponding to concept node 1004.

In particular embodiments, a concept node 1004 may represent a third-party webpage or resource hosted by a third-party system 970. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 930 to send to social-networking system 960 a message indicating the user's action. In response to the message, social-networking system 960 may create an edge (e.g., a check-in-type edge) between a user node 1002 corresponding to the user and a concept node 1004 corresponding to the third-party webpage or resource and store edge 1006 in one or more data stores.

In particular embodiments, a pair of nodes in social graph 1000 may be connected to each other by one or more edges 1006. An edge 1006 connecting a pair of nodes may represent a relationship between the pair of nodes. In particular embodiments, an edge 1006 may include or represent one or more data objects or attributes corresponding to the relationship between a pair of nodes. As an example and not by way of limitation, a first user may indicate that a second user is a “friend” of the first user. In response to this indication, social-networking system 960 may send a “friend request” to the second user. If the second user confirms the “friend request,” social-networking system 960 may create an edge 1006 connecting the first user's user node 1002 to the second user's user node 1002 in social graph 1000 and store edge 1006 as social-graph information in one or more of data stores 964. In the example of FIG. 10, social graph 1000 includes an edge 1006 indicating a friend relation between user nodes 1002 of user “A” and user “B” and an edge indicating a friend relation between user nodes 1002 of user “C” and user “B.” Although this disclosure describes or illustrates particular edges 1006 with particular attributes connecting particular user nodes 1002, this disclosure contemplates any suitable edges 1006 with any suitable attributes connecting user nodes 1002. As an example and not by way of limitation, an edge 1006 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 1000 by one or more edges 1006.

In particular embodiments, an edge 1006 between a user node 1002 and a concept node 1004 may represent a particular action or activity performed by a user associated with user node 1002 toward a concept associated with a concept node 1004. As an example and not by way of limitation, as illustrated in FIG. 10, a user may “like,” “attended,” “played,” “listened,” “cooked,” “worked at,” or “watched” a concept, each of which may correspond to an edge type or subtype. A concept-profile page corresponding to a concept node 1004 may include, for example, a selectable “check in” icon (such as, for example, a clickable “check in” icon) or a selectable “add to favorites” icon. Similarly, after a user clicks these icons, social-networking system 960 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 960 may create a “listened” edge 1006 and a “used” edge (as illustrated in FIG. 10) between user nodes 1002 corresponding to the user and concept nodes 1004 corresponding to the song and application to indicate that the user listened to the song and used the application. Moreover, social-networking system 960 may create a “played” edge 1006 (as illustrated in FIG. 10) between concept nodes 1004 corresponding to the song and the application to indicate that the particular song was played by the particular application. In this case, “played” edge 1006 corresponds to an action performed by an external application (SPOTIFY) on an external audio file (the song “Imagine”). Although this disclosure describes particular edges 1006 with particular attributes connecting user nodes 1002 and concept nodes 1004, this disclosure contemplates any suitable edges 1006 with any suitable attributes connecting user nodes 1002 and concept nodes 1004. Moreover, although this disclosure describes edges between a user node 1002 and a concept node 1004 representing a single relationship, this disclosure contemplates edges between a user node 1002 and a concept node 1004 representing one or more relationships. As an example and not by way of limitation, an edge 1006 may represent both that a user likes and has used at a particular concept. Alternatively, another edge 1006 may represent each type of relationship (or multiples of a single relationship) between a user node 1002 and a concept node 1004 (as illustrated in FIG. 10 between user node 1002 for user “E” and concept node 1004 for “SPOTIFY”).

In particular embodiments, social-networking system 960 may create an edge 1006 between a user node 1002 and a concept node 1004 in social graph 1000. As an example and not by way of limitation, a user viewing a concept-profile page (such as, for example, by using a web browser or a special-purpose application hosted by the user's client system 930) may indicate that he or she likes the concept represented by the concept node 1004 by clicking or selecting a “Like” icon, which may cause the user's client system 930 to send to social-networking system 960 a message indicating the user's liking of the concept associated with the concept-profile page. In response to the message, social-networking system 960 may create an edge 1006 between user node 1002 associated with the user and concept node 1004, as illustrated by “like” edge 1006 between the user and concept node 1004. In particular embodiments, social-networking system 960 may store an edge 1006 in one or more data stores. In particular embodiments, an edge 1006 may be automatically formed by social-networking system 960 in response to a particular user action. As an example and not by way of limitation, if a first user uploads a picture, watches a movie, or listens to a song, an edge 1006 may be formed between user node 1002 corresponding to the first user and concept nodes 1004 corresponding to those concepts. Although this disclosure describes forming particular edges 1006 in particular manners, this disclosure contemplates forming any suitable edges 1006 in any suitable manner.

In particular embodiments, social-networking system 960 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 970 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 960 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 960 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 960 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 960 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 960 may calculate a coefficient based on a user's actions. Social-networking system 960 may monitor such actions on the online social network, on a third-party system 970, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 960 may calculate a coefficient based on the user's actions with particular types of content. The content may be associated with the online social network, a third-party system 970, or another suitable system. The content may include users, profile pages, posts, news stories, headlines, instant messages, chat room conversations, emails, advertisements, pictures, video, music, other suitable objects, or any combination thereof. Social-networking system 960 may analyze a user's actions to determine whether one or more of the actions indicate an affinity for subject matter, content, other users, and so forth. As an example and not by way of limitation, if a user frequently posts content related to “coffee” or variants thereof, social-networking system 960 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 960 may calculate a coefficient based on the type of relationship between particular objects. Referencing the social graph 1000, social-networking system 960 may analyze the number and/or type of edges 1006 connecting particular user nodes 1002 and concept nodes 1004 when calculating a coefficient. As an example and not by way of limitation, user nodes 1002 that are connected by a spouse-type edge (representing that the two users are married) may be assigned a higher coefficient than a user nodes 1002 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 960 may determine that the user has a higher coefficient with respect to the first photo than the second photo because having a tagged-in-type relationship with content may be assigned a higher weight and/or rating than having a like-type relationship with content. In particular embodiments, social-networking system 960 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 960 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 1000. As an example and not by way of limitation, social-graph entities that are closer in the social graph 1000 (i.e., fewer degrees of separation) may have a higher coefficient than entities that are further apart in the social graph 1000.

In particular embodiments, social-networking system 960 may calculate a coefficient based on location information. Objects that are geographically closer to each other may be considered to be more related or of more interest to each other than more distant objects.

In particular embodiments, the coefficient of a user towards a particular object may be based on the proximity of the object's location to a current location associated with the user (or the location of a client system 930 of the user). A first user may be more interested in other users or concepts that are closer to the first user. As an example and not by way of limitation, if a user is one mile from an airport and two miles from a gas station, social-networking system 960 may determine that the user has a higher coefficient for the airport than the gas station based on the proximity of the airport to the user.

In particular embodiments, social-networking system 960 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 960 may provide information that is relevant to user's interests and current circumstances, increasing the likelihood that they will find such information of interest. In particular embodiments, social-networking system 960 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 960 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 960 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 970 (e.g., via an API or other communication channel), or from another suitable system. In response to the request, social-networking system 960 may calculate the coefficient (or access the coefficient information if it has previously been calculated and stored). In particular embodiments, social-networking system 960 may measure an affinity with respect to a particular process. Different processes (both internal and external to the online social network) may request a coefficient for a particular object or set of objects. Social-networking system 960 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, U.S. patent application Ser. No. 12/978265, filed 23 Dec. 2010, and U.S. patent application Ser. No. 13/632869, filed 1 Oct. 2012, each of which is incorporated by reference.

FIG. 11 illustrates an example computer system 1100. In particular embodiments, one or more computer systems 1100 perform one or more steps of one or more methods described or illustrated herein. In particular embodiments, one or more computer systems 1100 provide functionality described or illustrated herein. In particular embodiments, software running on one or more computer systems 1100 performs one or more steps of one or more methods described or illustrated herein or provides functionality described or illustrated herein. Particular embodiments include one or more portions of one or more computer systems 1100. Herein, reference to a computer system may encompass a computing device, and vice versa, where appropriate. Moreover, reference to a computer system may encompass one or more computer systems, where appropriate.

This disclosure contemplates any suitable number of computer systems 1100. This disclosure contemplates computer system 1100 taking any suitable physical form. As example and not by way of limitation, computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1100 may include one or more computer systems 1100; be unitary or distributed; span multiple locations; span multiple machines; span multiple data centers; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

In particular embodiments, computer system 1100 includes a processor 1102, memory 1104, storage 1106, an input/output (I/O) interface 1108, a communication interface 1110, and a bus 1112. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage 1106; decode and execute them; and then write one or more results to an internal register, an internal cache, memory 1104, or storage 1106. In particular embodiments, processor 1102 may include one or more internal caches for data, instructions, or addresses. This disclosure contemplates processor 1102 including any suitable number of any suitable internal caches, where appropriate. As an example and not by way of limitation, processor 1102 may include one or more instruction caches, one or more data caches, and one or more translation lookaside buffers (TLBs). Instructions in the instruction caches may be copies of instructions in memory 1104 or storage 1106, and the instruction caches may speed up retrieval of those instructions by processor 1102. Data in the data caches may be copies of data in memory 1104 or storage 1106 for instructions executing at processor 1102 to operate on; the results of previous instructions executed at processor 1102 for access by subsequent instructions executing at processor 1102 or for writing to memory 1104 or storage 1106; or other suitable data. The data caches may speed up read or write operations by processor 1102. The TLBs may speed up virtual-address translation for processor 1102. In particular embodiments, processor 1102 may include one or more internal registers for data, instructions, or addresses. This disclosure contemplates processor 1102 including any suitable number of any suitable internal registers, where appropriate. Where appropriate, processor 1102 may include one or more arithmetic logic units (ALUs); be a multi-core processor; or include one or more processors 1102. Although this disclosure describes and illustrates a particular processor, this disclosure contemplates any suitable processor.

In particular embodiments, memory 1104 includes main memory for storing instructions for processor 1102 to execute or data for processor 1102 to operate on. As an example and not by way of limitation, computer system 1100 may load instructions from storage 1106 or another source (such as, for example, another computer system 1100) to memory 1104. Processor 1102 may then load the instructions from memory 1104 to an internal register or internal cache. To execute the instructions, processor 1102 may retrieve the instructions from the internal register or internal cache and decode them. During or after execution of the instructions, processor 1102 may write one or more results (which may be intermediate or final results) to the internal register or internal cache. Processor 1102 may then write one or more of those results to memory 1104. In particular embodiments, processor 1102 executes only instructions in one or more internal registers or internal caches or in memory 1104 (as opposed to storage 1106 or elsewhere) and operates only on data in one or more internal registers or internal caches or in memory 1104 (as opposed to storage 1106 or elsewhere). One or more memory buses (which may each include an address bus and a data bus) may couple processor 1102 to memory 1104. Bus 1112 may include one or more memory buses, as described below. In particular embodiments, one or more memory management units (MMUs) reside between processor 1102 and memory 1104 and facilitate accesses to memory 1104 requested by processor 1102. In particular embodiments, memory 1104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1104 may include one or more memories 1104, where appropriate. Although this disclosure describes and illustrates particular memory, this disclosure contemplates any suitable memory.

In particular embodiments, storage 1106 includes mass storage for data or instructions. As an example and not by way of limitation, storage 1106 may include a hard disk drive (HDD), a floppy disk drive, flash memory, an optical disc, a magneto-optical disc, magnetic tape, or a Universal Serial Bus (USB) drive or a combination of two or more of these. Storage 1106 may include removable or non-removable (or fixed) media, where appropriate. Storage 1106 may be internal or external to computer system 1100, where appropriate. In particular embodiments, storage 1106 is non-volatile, solid-state memory. In particular embodiments, storage 1106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1106 taking any suitable physical form. Storage 1106 may include one or more storage control units facilitating communication between processor 1102 and storage 1106, where appropriate. Where appropriate, storage 1106 may include one or more storages 1106. Although this disclosure describes and illustrates particular storage, this disclosure contemplates any suitable storage.

In particular embodiments, I/O interface 1108 includes hardware, software, or both, providing one or more interfaces for communication between computer system 1100 and one or more I/O devices. Computer system 1100 may include one or more of these I/O devices, where appropriate. One or more of these I/O devices may enable communication between a person and computer system 1100. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1108 for them. Where appropriate, I/O interface 1108 may include one or more device or software drivers enabling processor 1102 to drive one or more of these I/O devices. I/O interface 1108 may include one or more I/O interfaces 1108, where appropriate. Although this disclosure describes and illustrates a particular I/O interface, this disclosure contemplates any suitable I/O interface.

In particular embodiments, communication interface 1110 includes hardware, software, or both providing one or more interfaces for communication (such as, for example, packet-based communication) between computer system 1100 and one or more other computer systems 1100 or one or more networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1110 for it. As an example and not by way of limitation, computer system 1100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1100 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1100 may include any suitable communication interface 1110 for any of these networks, where appropriate. Communication interface 1110 may include one or more communication interfaces 1110, where appropriate. Although this disclosure describes and illustrates a particular communication interface, this disclosure contemplates any suitable communication interface.

In particular embodiments, bus 1112 includes hardware, software, or both coupling components of computer system 1100 to each other. As an example and not by way of limitation, bus 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1112 may include one or more buses 1112, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method, by one or more computer systems of a social-networking system, comprising:
querying a social graph of the social-networking system for social content generated by a plurality of users of the social-networking system;
determining a subset of the social content that is about at least one of a plurality of television programs;
determining first users of the plurality of users of the social-networking system who posted or interacted with the subset of social content that is about at least one of a plurality of television programs;
generating a panel of users who have engaged with at least one of the plurality of television programs on the social-networking system, the panel of users comprising the determined first users;
analyzing additional posts to the social-networking system to determine particular posts that mention one or more actors associated with at least one of the plurality of television programs;
determining second users of the plurality of users of the social-networking system who posted or interacted with the particular posts that mention one or more actors associated with at least one of a plurality of television programs;
updating the panel of users who have engaged with one or more of plurality of television programs on the social-networking system by adding the second users to the panel; and
providing, for display in a graphical user interface, one or more television insights using the updated panel of users who have engaged with one or more of plurality of television programs on the social-networking system.

2. The method of claim 1, further comprising:
providing, for display in the graphical user interface, a list of available television programs; and
receiving a user selection of a particular television program from the list of available television programs;
wherein the provided one or more television insights each show information about the selected particular television program.

3. The method of claim 1, wherein the provided one or more television insights comprises a show ranking insight that provides a graphical representation of a ranking of the plurality of television programs according to a total amount of engagement by the panel over a certain time period.

4. The method of claim 1, wherein the provided one or more television insights comprises an engagement volume insight that provides a graphical representation of engagement volume by the panel over a certain time period for a selected television program.

5. The method of claim 1, wherein the provided one or more television insights comprises a demographic insight that provides a graphical representation of engagement volume by the panel for a selected television program for certain demographics.

6. The method of claim 1, wherein the provided one or more television insights comprises a carrier affinity insight that provides a graphical representation of engagement volume by the panel for a selected television program for certain carriers.

7. The method of claim 1, wherein the social content comprises one or more of:
a post;
a comment;
a reaction;
an indication that content has been shared;
an indication that a hyperlink has been selected; and
an indication that a video has been at least partially viewed.

8. One or more computer-readable non-transitory storage media embodying software that is operable when executed to:
query a social graph of the social-networking system for social content about at least one of a plurality of television programs;
generate a panel of users who have engaged with one or more of the plurality of television programs on the social-networking system, the panel of users comprising a first plurality of users who posted or interacted with the social content that is about at least one of a plurality of television programs;
determine particular posts that mention one or more actors associated with at least one of the plurality of television programs;
determine a plurality of second users of the social-networking system who posted or interacted with at least one of the particular posts that mention one or more actors associated with at least one of a plurality of television programs;
update the panel of users who have engaged with one or more of plurality of television programs on the social-networking system to include the plurality of second users; and
provide, in a graphical user interface, one or more television insights using the updated panel of users who have engaged with one or more of plurality of television programs on the social-networking system.

9. The media of claim 8, wherein the software is further operable when executed to:
provide, for display in the graphical user interface, a list of available television programs; and
receive a user selection of a particular television program from the list of available television programs;
wherein the provided one or more television insights each show information about the selected particular television program.

10. The media of claim 8, wherein the provided one or more television insights comprises a show ranking insight that provides a graphical representation of a ranking of the plurality of television programs according to a total amount of engagement by the panel over a certain time period.

11. The media of claim 8, wherein the provided one or more television insights comprises an engagement volume insight that provides a graphical representation of engagement volume by the panel over a certain time period for a selected television program.

12. The media of claim 8, wherein the provided one or more television insights comprises a demographic insight that provides a graphical representation of engagement volume by the panel for a selected television program for certain demographics.

13. The media of claim 8, wherein the provided one or more television insights comprises a carrier affinity insight that provides a graphical representation of engagement volume by the panel for a selected television program for certain carriers.

14. The media of claim 8, wherein the social content comprises one or more of:
a post;
a comment;
a reaction;
an indication that content has been shared;
an indication that a hyperlink has been selected; and
an indication that a video has been at least partially viewed.

15. A system comprising:
one or more processors; and
one or more computer-readable non-transitory storage media coupled to one or more of the processors and comprising instructions operable when executed by one or more of the processors to cause the system to:
querying a social graph of the social-networking system for social content about at least one of a plurality of television programs;
generating a panel of users who have engaged with one or more of the plurality of television programs on the social-networking system, the panel of users comprising a first plurality of users who posted or interacted with the social content that is about at least one of a plurality of television programs;
determining particular posts that mention one or more actors associated with at least one of the plurality of television programs;
determining a plurality of second users of the social-networking system who posted or interacted with at least one of the particular posts that mention one or more actors associated with at least one of a plurality of television programs;
updating the panel of users who have engaged with one or more of plurality of television programs on the social-networking system to include the plurality of second users; and
providing, in a graphical user interface, one or more television insights using the updated panel of users who have engaged with one or more of plurality of television programs on the social-networking system.

16. The system of claim 15, wherein the processors are further operable when executing the instructions to:
provide, for display in the graphical user interface, a list of available television programs; and
receive a user selection of a particular television program from the list of available television programs;
wherein the provided one or more television insights each show information about the selected particular television program.

17. The system of claim 15, wherein the provided one or more television insights comprises a show ranking insight that provides a graphical representation of a ranking of the plurality of television programs according to a total amount of engagement by the panel over a certain time period.

18. The system of claim 15, wherein the provided one or more television insights comprises an engagement volume insight that provides a graphical representation of engagement volume by the panel over a certain time period for a selected television program.

19. The system of claim 15, wherein the provided one or more television insights comprises a demographic insight that provides a graphical representation of engagement volume by the panel for a selected television program for certain demographics.

20. The system of claim 15, wherein the provided one or more television insights comprises a carrier affinity insight that provides a graphical representation of engagement volume by the panel for a selected television program for certain carriers.
